(19) United States
(12) Patent Application Publication
(10) Pub. No.: US 2024/0044749 A1
(43) Pub. Date: Feb. 8, 2024

(54) METHOD AND SYSTEM FOR PRESSURIZED COMPONENT TEST PLAN OPTIMIZATION

(71) Applicant: Hecate Software, Inc., Richland, WA (US)

(72) Inventors: Eric A. Livesay, Richland, WA (US); Brian LaMarche, Richland, WA (US)

(21) Appl. No.: 18/364,468

(22) Filed: Aug. 2, 2023

Related U.S. Application Data
(60) Provisional application No. 63/394,557, filed on Aug. 2, 2022.

(51) Int. Cl. G01M 99/00

(52) U.S. Cl. CPC G01M 99/008

(57) ABSTRACT

Provided is a method for generating a pressure test plan comprising generating, by a computing system, a first set of tests for a set of pressurized components of a pressurized system; determining, by the computing system, a fitness scores for the tests of the first set; and generating an updated set of tests based on the fitness scores of the tests.

### CROSS-REFERENCE TO RELATED APPLICATIONS

This application claims priority to U.S. Provisional Application No. 63/394,557, filed Aug. 2, 2023, the entire content of which is incorporated herein by reference in its entirety.

### BACKGROUND

### 1. Field

The present disclosure relates generally to pressure analysis and, more particularly, to computer generated pressure test plans.

### 2. Description of the Related Art

In the oil and gas industry, pressurized components are ubiquitous. It is necessary to periodically monitor components' response to pressure, ability to shut, and other pressure performance parameters.

A series of tests (e.g., pressure tests) may be used to monitor performance of a set of components, where the design of the series of tests may be obtained in a number of ways.

### SUMMARY

The following is a non-exhaustive listing of some aspects of the present techniques. These and other aspects are described in the following disclosure.

Some aspects include a set of software components and non-transitory, computer-readable media that may be used to generate a test plan (e.g., a series of tests).

Some aspects include a set of software components and non-transitory, computer-readable media that may be used to evaluate elements of a test plan.

Some aspects include a set of software components and non-transitory, computer-readable media that may be used to acquire data based on an implemented test.

Some aspects include a set of software components and non-transitory, computer-readable media that may be used to update a test plan based on acquired information about an implemented test.

Some aspects include a set of software components and non-transitory, computer-readable media that may be used to determine a time response of one or more components to a test or test plan.

Some aspects include a tangible, non-transitory, machine-readable medium storing instructions that, when executed by a data processing apparatus cause the data processing apparatus to perform operations, including the process as mentioned above.

Some aspects include a system, including one or more processors, and memory storing instructions that, when executed by the processors, cause the processors to effectuate operations of the above-mentioned process.

It should be appreciated that the present invention can be implemented in numerous ways, including as a process, an apparatus, a system, a device, a method, or a computer-readable medium. Several inventive embodiments of the present invention are described below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above-mentioned aspects and other aspects of the present techniques will be better understood when the present application is read in view of the following figures in which like numbers indicate similar or identical elements:

FIG. 1 is a screen shot of an example software component (e.g., Blueprint) which shows a digital copy of a physical setup of equipment, according to some embodiments.

FIG. 2 is a representational diagram of example software components, according to some embodiments.

FIGS. 3A-3C are a diagrams depicting three different physical configurations (e.g., rig-ups) for a Test Plan, according to some embodiments.

FIGS. 4A-4B are a representational diagrams depicting a rig up and corresponding component properties and component tracking information, according to some embodiments.

FIG. 5 is a diagram depicting an example gene, including a series of tests and a table depicting components tested in each test, according to some embodiments.

FIG. 6 is a diagram depicting an example rig up with an isolated cavity, according to some embodiments.

FIG. 7 is a schematic diagram depicting evolution of genes, according to some embodiments.

FIG. 8 is a flowchart depicting an example method for test plan creation by a genetic algorithm, according to some embodiments.

FIGS. 9A-9C are schematic diagrams depicting a relationship between generations of genes, according to some embodiments. FIG. 9A depicts a diagram of a generation 0. FIG. 9B is a flowchart depicting an example method for production of a subsequent generation. FIG. 9C depicts a diagram of a generation 1, descended from the generation 0 of FIG. 9A.

FIG. 10 is a schematic diagram of process flow, according to some embodiments.

FIG. 11 illustrates an example of a computing device by which the present techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of target detection and tracking (e.g., radar design and computer vision). Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

As used herein, “optimal” may refer to something (e.g., test plan, test, component configuration, etc.) that corresponds to a result of an optimization procedure, including a global or local maximum or minimum. Optimal should not be taken as limiting an object to the absolute greatest, best, or any other superlative for all possible orientations, values, considerations, etc. of said object. It should be understood that optimal may refer to a best iteration (e.g., of a solution, series, configuration, etc.) such as can be practically described by limitations of computational power, time, accuracy, reproducibility, etc. Multiple elements may be identified as optimal in some embodiments. In some embodiments, further determination may be used to choose a most optimal element from among a set of elements identified as optimal.

In some embodiments, a test series may be performed on a series of components in various configurations (e.g., opened, closed, pressurized from the right, pressurized from the left, etc.).

In some embodiments, a software component may use machine learning algorithms to determine test plans, which may include use of a genetic algorithm.

In some embodiments, a software component may operate on collected data for one or more tests in order to update a test plan and/or generate a new test plan.

In some embodiments, a software component may track information about one or more components.

In some embodiments, test plans and/or test may be stored in cloud storage, such as for access by various users and for comparison with test plans and/or test over time or at different test locations.

In some embodiments, a software component may track test plans and may operate to select test plans which reduce equipment wear (e.g., exposure to pressure).

In some embodiments, a test plan may be implemented by a software component.

In some embodiments, data for an implemented test plan may be acquired by a software component.

In some embodiments, multiple software components may be in communication with each other and, optionally, components to determine, implement, and acquire data for one or more test plans.

Examples are presented below in a technical document that describes aspects of a negative pressure testing with the present techniques. This technical document is followed by a description of a computer system upon which the present techniques may be implemented.

Examples are best understood with reference to the description, which describes certain embodiments consistent with the present techniques. Arguably limiting language like “each”, “including”, “optimal”, “maximum”, “minimum” etc. and their grammatical equivalents, should be read as merely referring to certain embodiments and is not intended to be limiting of all embodiments of the present disclosure. It should be understood that elements referred to as software components may be present as separate software components or integrated into one or more software components. Names provided for software components are provided for ease of description and are not limiting. Ranges may be inclusive or exclusive.

The following describes a set of software tools and non-transitory computer readable media that optimize a Test Plan for pressure testing of well-control equipment within the oil & gas industry, in accordance with some embodiments of this disclosure. Some embodiments may have potential application to testing, diagnostic analysis, and monitoring of pressure/flow control systems during drilling, completions, work-over, and intervention of wells, including but not limited to systems related to the well itself (e.g., in the annulus), wellhead, trees, manifolds, jumpers, flowlines, topside components, tools, and pipelines.

In some embodiments a system may introduce an ability to find one or more optimal configurations of sealable equipment that may minimize a time required for testing of equipment. In some embodiments, the system may instead be an algorithm that generates an optimal test plan or may include an algorithm that generates an optimal test plan.

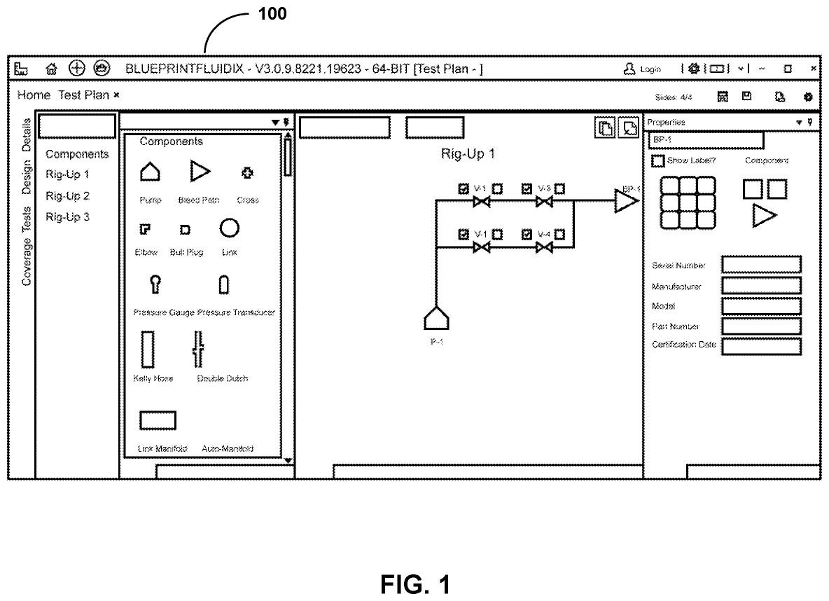

Some embodiments may comprise or may be implemented by (or within) pieces of software, which may be included in a suite of software. Relationships between software components may be as broadly depicted in FIG. 1, described in further detail later. In some embodiments, these pieces of software are described as:

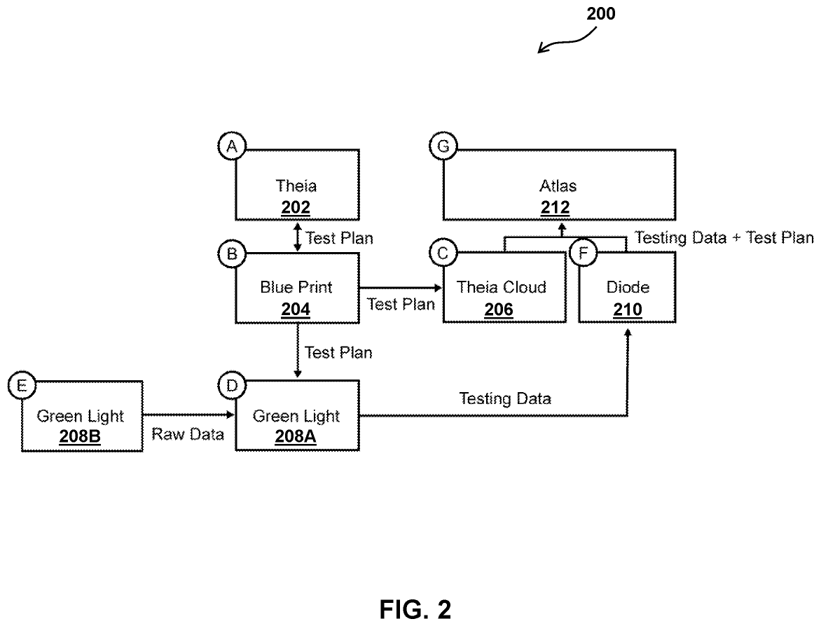

Theia—a software component (element A of FIG. 2) that may use machine learning algorithms to find optimal test plans (where test plans may be generated by Blueprint or another software component). An optimal test plan may be one that has been found to have a minimum number of Tests and/or may reduce the amount of pressure being placed on a given component. In some embodiments, this software may be embedded in Blueprint or another software component and may run in the cloud to help train the machine learning algorithms.

Blueprint—a software component (element B of FIG. 2) that may be a computer aided drafting (CAD) software. In some embodiments, Blueprint may allow users to generate schematics of component layouts and their fluidic connections. In some embodiments, the software component may track information about equipment including manufacturer, make, model, serial number, part number, rated working pressure, maximum pressure, etc. The software may then track how a media contained within the system may flow under pressure. In some embodiments, users may be able to set criteria on whether equipment (e.g., piece by piece) is required to be tested, to what pressure, and in what configuration (e.g., from the left or the right). In some embodiments, Blueprint users may then be allowed to create a series of Tests that are indicated as required. In some embodiments, a series of Tests may be suggested to users. Within each Test, Blueprint may track whether a component is sealed or not sealed. In some embodiments, Blueprint may analyze pressurized pathways for Tests through the system to automatically determine if given piece of equipment has been tested in a given Test or across all Tests. In some embodiments, these criteria may be reported to the user who determines whether all equipment that is required to be tested (e.g., for safety testing reasons, for wear testing reasons, etc.), is tested to the expected criteria. In some embodiments, Blueprint may use a configuration file called settings.json to store analysis parameters and other settings used by the application and/or software component. In some embodiments, the software component may produce a binary file with extension BRX as output per Test Plan.

Theia Cloud—a software component (element D of FIG. 2) that may use machine learning algorithms to determine similarities between test plans for a given rig or across a set of rigs. In some embodiments, similarity metrics may be used to suggest further improvements to a test plan or act as starter test plans for rigs with similar setups.

Atlas—a software component (element G of FIG. 2) that may track test plans and may use information to help find optimal test plans to reduce equipment exposure to pressure. In some embodiments, Atlas may contain a database system, which may be a database system Dione (element F of FIG. 2) or another database system, which may track equipment use, raw pressure data, and other items used during digital pressure testing. In some embodiments, Atlas may have features that allow for test plan management, review, and version tracking. In some embodiments, Atlas may also marry the test pressure testing output generated by GreenLight with Test Plan data to help estimate wear to support preventative maintenance efforts.

GreenLight—a piece of software component (element D of FIG. 2) that may receive pressure and temperature data from a server software (e.g., element E of FIG. 2), e.g., Analogue or another server software, and may perform advanced analytics on the pressure data over time, hereafter referred to as {tP} data where temperature is also implied. In some embodiments, GreenLight may use a set of algorithms called analysts to analyze the {tP} data to determine if a Test passes or fails. In some embodiments, GreenLight may provide a failing (red), inconclusive (yellow), or passing (green) indicator when it determines if a test has met or failed to meet criteria entered by the user, including but not limited to, the test pressure or required time duration of the test. In some embodiments, GreenLight may use a configuration file called settings.json to store analysis parameters and other settings used by the application. In some embodiments, GreenLight may produce a binary file with extension GRX as output. In some embodiments, Test Plan configurations, such as Test Plan configurations generated by Blueprint and/or Theia, may be used by GreenLight during testing of equipment. In some embodiments, GreenLight may use the Test Plan to verify that the correct valves are physically opened or closed during testing.

In some embodiments, a Test Plan may document a physical system that is to be tested. The physical system may be, but not limited to, well control equipment, well safety equipment, drilling and production equipment, and any other piece of equipment used as part of oil and gas drilling or production. In some embodiments, a user that is familiar with the equipment to be tested may use Blueprint to create a digital copy of the physical system. In some embodiments, Blueprint may acquire CAD or other information about the physical system. Blueprint may also capture information about the location of testing, types of media used for testing, dates of testing, facility the testing occurred on and identify the parties involved in testing.

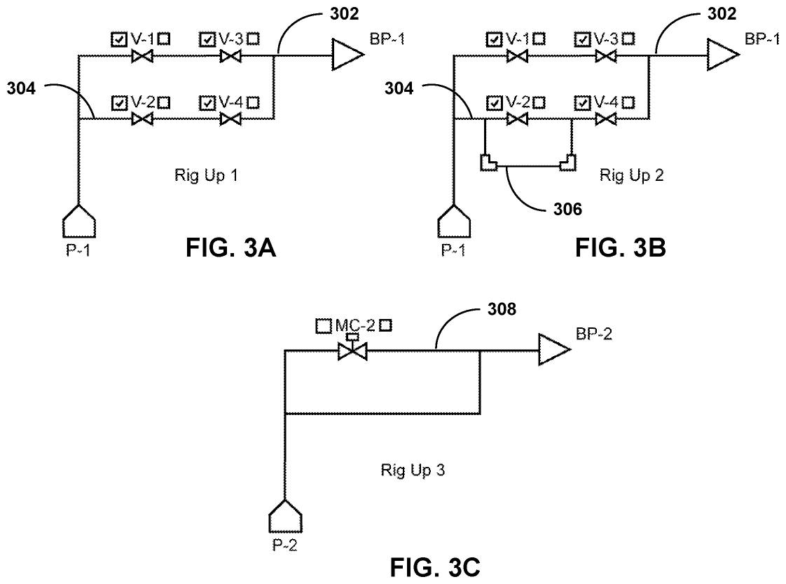

The digital Test Plan physical system may be represented as a digital design that maps pathways of media (e.g., drilling mud, oil, salt water, water, steam, natural gas, etc.) under pressure for the purpose of testing equipment. In some embodiments, the Test Plan may capture different physical setups as different designs. Different designs may be denoted as “rig-ups” in the software components, such as depicted in FIGS. 3A-3C. A rig-up may capture differences between fluid handling set ups, such as where a pipe may be used as a bypass in one setup, but may be omitted in a different configuration.

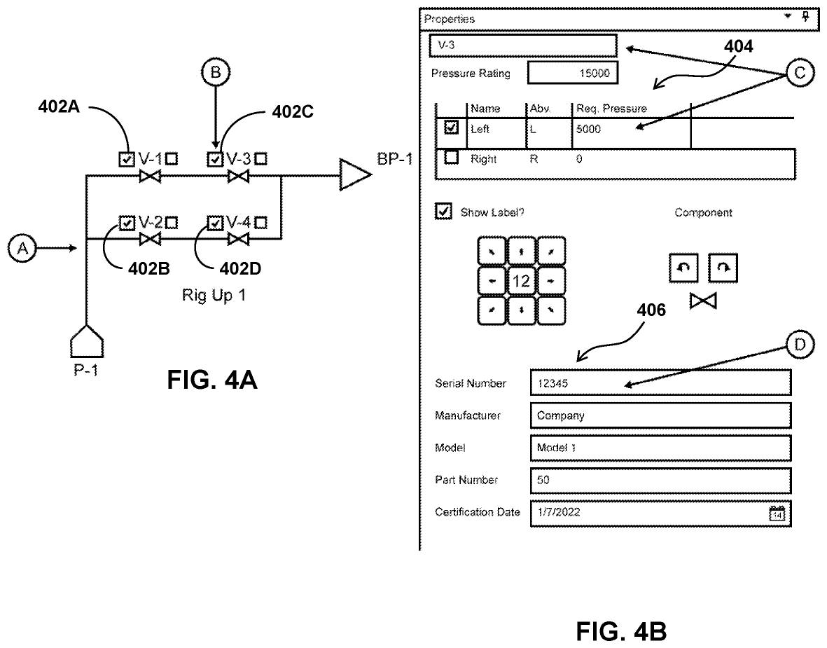

In some embodiments, the Test Plan may track how equipment, also called components, are to be tested. In some embodiments, may specify (e.g., for each component) at least one of: 1) if the component is to be tested; 2) which side the component is to be tested from (e.g., upstream, downstream, or both); 3) the required pressure the component must be tested to; and/or 4) the pressure rating which the component is not exceed during testing. In some embodiments, other information about the components may also tracked including, but not limited to, manufacturer and model, serial numbers, and calibration dates, as depicted in FIG. 4B.

In some embodiments, the Test Plan may contain a series of Tests. In some embodiments, a Test may be a representation of the state of components as either be sealed or unsealed (e.g., closed or open) during a specific time frame, pressure build up, etc. In some embodiments, the collection of states of each component (e.g., of a rig up) may also be referred to as a line-up. In some embodiments, Tests may also track at least one of the test pressures to be applied during testing, the pipe sizes that may be used, general comments, a test type, a description of the Test, other meta-data related to testing that may be important for the user, or downstream analytics.

Theia may use the Test Plan and/or rig-up information to generate a set of Tests for the Test Plan, including automatically. In some embodiments, the user may enter a command in Blueprint (e.g., click a button) that may cause Theia to execute (e.g., initiate generation of Tests). In some embodiments, Theia may generate an optimal test plan using a genetic algorithm. The genetic algorithm (GA) may be a type of machine learning algorithm. In some embodiments, Theia may operate based on an ensemble of machine learning algorithms, instead of or in addition to a genetic algorithm.

In some embodiments, the input to the algorithm may be a design that may contain a single or multiple rig-ups representing the physical configuration of the system which is to be tested. Each rig-up design may contain a series of components. In some embodiments, each component may have a set of test specifications, which may be represented as a set of tuples: required side tested, required pressure for that side, component pressure rating.

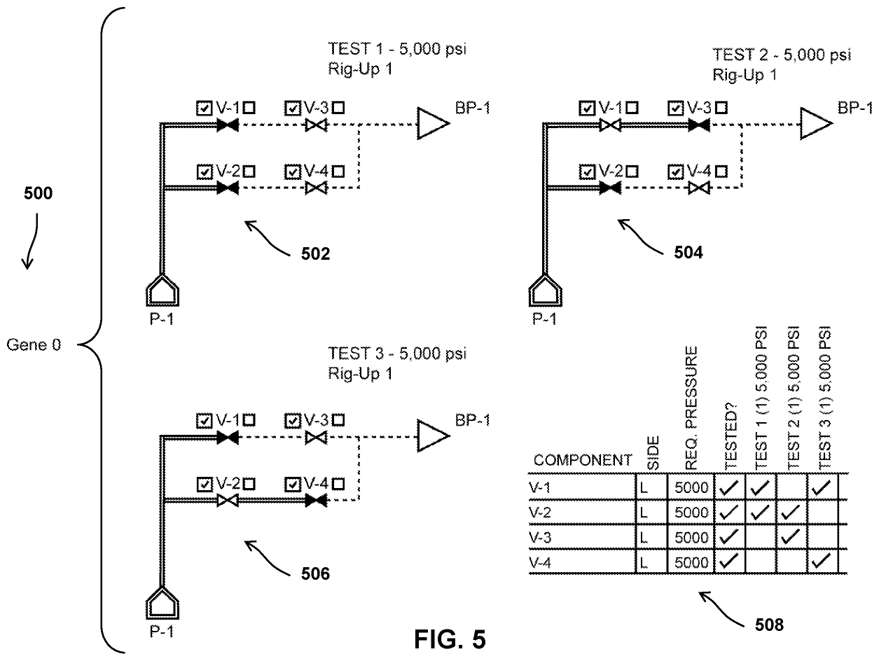

In some embodiments, a genetic algorithm (GA) may use the rig-up design to generate a series of genes. In some embodiments, each gene may represent a single Test Plan (such as depicted in FIG. 5). In some embodiments, the Test Plan may contain a series of Tests, such as generated by the Theia algorithm. In some embodiments, the GA may use a fitness function, where a fitness function may be a mathematical equation that scores how “fit” a gene is. The fit score may be used to determine the scale of how a Test Plan is good or bad, where good or bad may be judged based on conformation to rig up, number of tests necessary to test a line up, total pressure, conformation to component limits, etc.

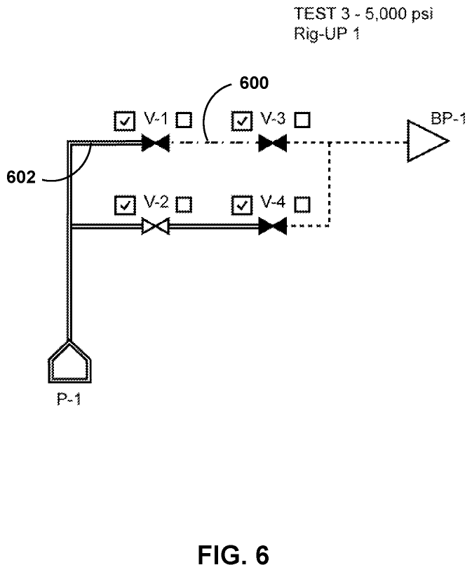

In some embodiments, each Test may have a Test Pressure which may represent the line-up of a rig-up as a Tuple of: component side, state (sealed or unsealed). In some embodiments, the fitness function may penalize a line-up and/or gene if errors exist. These errors may include, but are not limited to: an open flow path, an isolated cavity, over pressurization of a component, etc.
An open flow path may represent a physical configuration of connected elements where a pressure source, e.g., pump, would have a direct pathway to a pressure sink, e.g., trip tank. An open flow path may also be referred to as a bleed path.
An isolated cavity may represent two sealable elements that are both sealed in a Test inline between a pressure source and a pressure sink, which may create a portion of a line that is exposed to neither a pressure source nor a pressure sink (such as depicted in FIG. 6).
Over pressurization may occur when the pressure to be applied during a test (e.g., to a component) exceeds the rated working pressure recommended by an engineer, manufacturer, etc.

In some embodiments, once the initial set of genes is created, the GA may sort the genes based on fitness scores, may discard a partition of low scoring genes (where the discarded partition may comprise a majority, plurality, etc. of the genes), and may then create a set of new genes. In some embodiments, new genes may be generated by starting a new gene from a randomly generated line-up, copying a high scoring gene and slightly modifying the line-up (e.g., mutation), merging two genes into a single new gene via cross-over, etc.

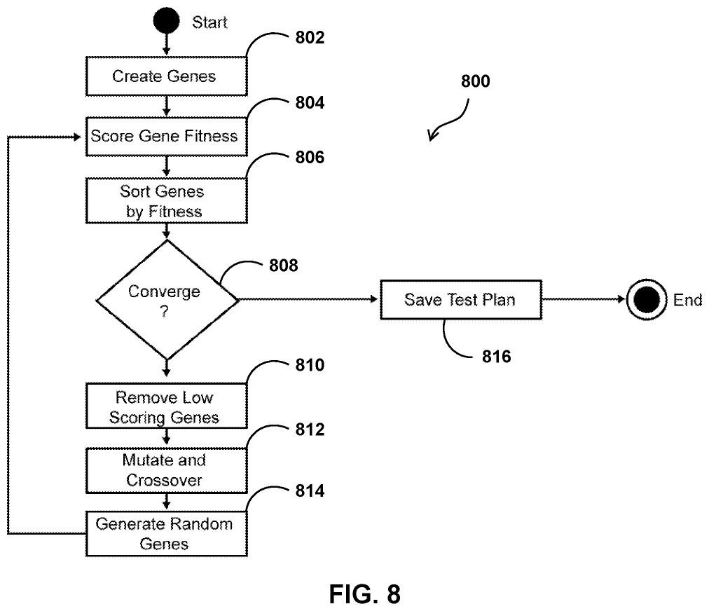

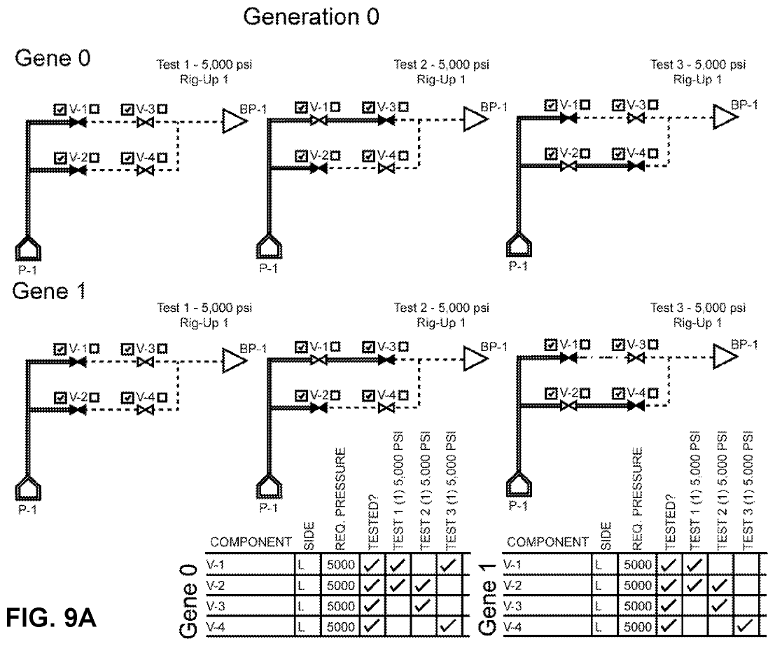

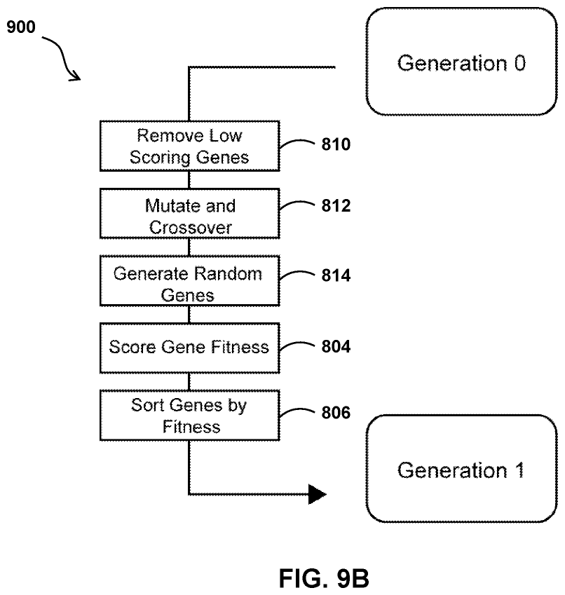

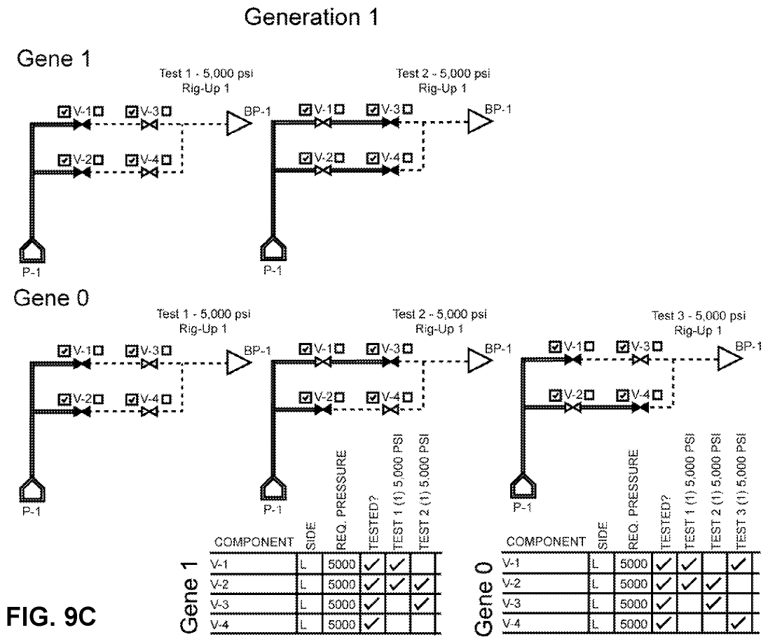

In some embodiments, his process may be repeated to create different generations of genes. In some embodiments, the highest scoring genes in each generation may be conserved until either the top scoring genes never change, a maximum number of generations has been reached, or another termination criterion. In some embodiments, the result may be a Test Plan that has an optimal number of Tests. The process of evolving from one generation to another, in some embodiments, is visually depicted in FIG. 6. The output test plan may have a minimal number of Tests in which all required sides of components to be tested are tested, to the correct pressure, and without over pressurization of components beyond their rated working pressures, with no Tests containing isolated cavities, and no Tests containing open flow paths. This process and logic flow, for some embodiments, is depicted in FIG. 8. FIGS. 9A-9C shows a Test product that Theia, in some embodiments, may produce as an optimal test plan from a simple design.

In some embodiments, once Theia determines a convergence of test plans the user may be allowed to accept the Test Plan. In some embodiments, in a case where there are multiple Test Plans that may be suitable for use by a facility, (where such multiple Test Plans may be almost identical but have subtle differences in line-ups), the multiple, suitable Test Plans may be considered candidates. In some embodiments, the multiple suitable candidates may all be uploaded to the Theia Cloud for storage and retrieval at a later time using Atlas.

In some embodiments, Theia Cloud may run calculations to determine the similarity of the setup (e.g., of the Test Plan) compared to other digital representations of the equipment. In some embodiments, the equipment specified in the test plan may then be entered into Atlas's database where it's use over time may be tracked. In some embodiments, this data may be combined with digital pressure testing data from GreenLight that may be used for assisting in optimal test plan generation. In some embodiments, this data may assist in tracking how equipment is being used, how long it's exposed to high pressure, etc.

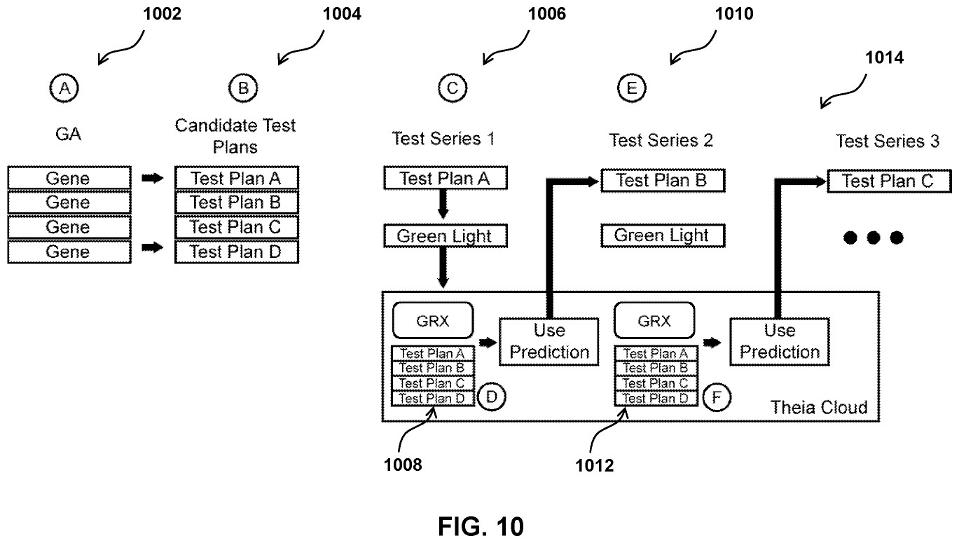

In some embodiments, Theia Cloud may suggest which Test Plan to use for an upcoming Test Series. A Test Series may represent the actual execution of the Tests performed by a facility. In some embodiments, the facility may run GreenLight (e.g., concurrent to the Test Series) to analyze pressure and temperature data. In some embodiments, the output of these testing data may be a GRX file. FIG. 10 visualizes, according to some embodiments, the process of Theia Cloud suggesting Test Plans for upcoming Test Series.

In some embodiments, after Theia has produces an optimal set of genes (as depicted by element A of FIG. 10) the Test Plans may be extracted from the GA (as depicted by element B of FIG. 10). In some embodiments, a user may use the top scoring Test Plan for Test Series 1 (as depicted by element C of FIG. 10). In some embodiments, GreenLight may be run and the output GRX file uploaded to Theia Cloud. In some embodiments, Theia Cloud may analyze the GRX data, calculate total time exposure for each equipment to pressure, and examine the existing Test Plans to suggest (as depicted by element D of FIG. 10) the Test Plan to use in the next Test Series (as depicted by element E of FIG. 10). In some embodiments, the facility may use the suggested Test Plan for line-up of equipment, and run GreenLight again. In some embodiments, the use prediction may be run again (as depicted by element F of FIG. 10) and an additional Test Plan may be suggested for the following Test Series. In some embodiments, this process may be repeated for each test plane (e.g., semi-indefinitely) or until some termination criterion (e.g., well shut-in) was reached.

In some embodiments, by cycling through Test Plans, equipment exposure to pressure may be reduced, and thus wear reduced. Reduced wear may imply a potential increase in time between maintenance and may reduce possibly equipment failures.

FIG. 1 is a screen shot 100 of an example software component (e.g., Blueprint) showing a digital copy of a physical set up of equipment. The screen shot includes headings for selecting various pages (e.g., coverage, tests, design, details, etc.) for performing one or more design or test function. Digital representations of fluid handling components, such as pump, bleed path, various connections, elbow, pressure gauge, plug, pressure transducer, Kelly hose, manifolds, diverter, etc., can be selected from a component menu or toolbox and used to create one or more flow path diagram or rig-up. The components may be dragged and dropped into a flow path diagram. The flow path diagram may be imported from another software program, such as from a CAD program. The diagram of the flow path may be displayed, together with information about components of the flow path such as valve identifiers. Properties of the components may be adjusted in a properties window. Properties of the component, such as name, serial number, manufacturer, part number, certification date, etc., may be stored with the component, such as in the flow path diagram.

FIG. 2 is a component view 200 of an example relationship between the software components of Blueprint 204, Theia 202, Greenlight 208A-208B, and Atlas 212. FIG. 2 depicts an example architecture of the software components. In some embodiments, test planning, testing, data management, etc. may be related as depicted in the component view.

Theia 202 may be a software component that may use machine learning algorithms to find optimal test plans, as previously described. Blueprint 204 may be a software component that may be a computer aided drafting (CAD) software, such as as-previously described. Theia 202 and Blueprint 204 may operate, including sequentially, or serially on one or more test plan, including by communicating test plans between Theia 202 and Blueprint 204. Theia 202 may be including as a software component of Blueprint 204

Theia Cloud 206 may be a software component, such as previously described, that may use machine learning algorithms to determine similarities between test plans for a given rig or across a set of rigs. Theia Cloud 206 may operate on output of Blueprint 204, including on proposed test plans, conducted test plans, test plans designed by Theia 202, user created test plans, etc.

Atlas 212 may be a software component that may track test plans and may use information to help find optimal test plans to reduce equipment exposure to pressure, such as as-previously described. In some embodiments, Atlas may contain a database system, which may be a database system Dione 210 or another database system, which may track equipment use, raw pressure data, and other items used during digital pressure testing. Atlas 212 may operate based on information from Dione 210 or another database system and from Theia Cloud 206. The input to Atlas 212 may be both testing data and a test plan. Atlas may operate based on both proposed test plans and based on historical data.

GreenLight 208A may be a piece of software component that may receive pressure and temperature data from a server software GreenLight 208B. GreenLight 208B may be any appropriate software server, e.g., Analogue or another server software, and may output raw data to GreenLight 208B. GreenLight 208A and GreenLight 208B may be an integrated software component. GreenLight 208B may operate on test plans output by Blueprint 204 to associate test plans and test data, such as to determine one or more trends in test data over time. Greenlight 208A may analyze raw data, test plans, etc. to determine if a test, component, flow path, etc. has passed or failed a test plan, or provided inconclusive results. GreenLight 208A and GreenLight 208B may perform any other functions as previously described. Functions described as performed by GreenLight 208A may be instead or additionally performed by GreenLight 208B, or vice versa.

FIGS. 3A-3B depict three different physical configurations, which are modeled for the same Test plan. The physical set ups are captured by three designs, which may be called “rig-ups”. FIG. 3A depicts Rig Up 1, FIG. 3B depicts Rig Up 2, and FIG. 3C depicts Rig Up 3. In some embodiments, there may be slight variations between rig-ups, as depicted by the slight variations shown between Rig-Up 1 and Rig-Up 2. Rig Up 1 of FIG. 3A depicts valves V-1 and valve V-3 along a first path 302 between pump P-1 and bleed path BP-1 and valves V-2 and valve V-3 along a second path 304 between pump P-1 and bleed path BP-1, where the first path 302 and the second path 304 are parallel (valves V-1 and V-3 are in series as are valves V-2 and V-4, where the pair of valves V-1 and V-3 are in parallel with the valves V-2 and V-4). Rig Up 2 of FIG. 3B depicts the flow path of Rig Up 1, with an additional diversion path 306, branching from the second path 304 before the valve V-2 and rejoining the second path 304 after the valve V-2 and before the valve V-4. In some embodiments, there may be larger variations between rig-ups, as depicted by the different set up shown in Rig-Up 3 (e.g., relative to Rig-Up 1 and/or Rig-Up 2). Rig Up 3 of FIG. 3C depicts motor-controlled valve MC-2 along a single path 308 between pump P-2 and bleed path BP-2.

FIGS. 4A-4B depict parts of a graphical display of an interface for testing. FIG. 4A depicts a design showing four (4) valves (e.g., V-1, V-2, V-3, V-4), a pump (e.g., P-1), and a bleed path (e.g., BP-1), which is substantially identical to Rig Up 1 of FIG. 3A. The valves are set to be tested from the left (as indicated by checkmarks in boxes 402A-402D on the left sides of the valves V-1, V-2, V-3, V-4 with corresponding empty boxes on the right sides of the valves). FIG. 4B depicts properties of the various components of the design of FIG. 4A. Test related information about the components may be set in an information table 404. For example, pressure rating, required test side, pressure, etc. can be set, displayed, changed, etc. In some embodiments, component tracking may also be added or viewed, such as by input into or display fields 406.

FIG. 5 depicts an example of a gene 500, according to some embodiments. An example gene 500 (e.g., “Gene 0”) is depicted, which consists of three (3) tests (e.g., test 1 502, test 2 504, test 3 506) and a table 508. Each of the tests shown corresponds to a single rig up (e.g., Rig-Up 1 of FIG. 3A and FIG. 4A) but tests may instead correspond to different rig-ups. High pressure is indicated by red lines, while low pressure is indicated by blue lines (as provided in the accompanying color figures). Closed valves are indicated by black coloring. Open valves are indicated by black outlines and white fill. Open valves may experience little or no pressure differential, where pressure is substantially similar on each side of the open valve. Closed valves may experience no pressure differential, if the pressure is substantially similar on each side of the closed valve, or may experience substantially nonzero pressure differential (e.g., a pressure drop or increase) if the pressure is substantially different on various sides of the valve, such as provided by an active pump on a first side of the valve and a bleed path on a second side of the pump.

Test 1 502 depicts high pressure from pump P-1 charging lines up to closed valves V-1 and V-2 (which are in parallel), with valves V-3 and V-4 open and open to bleed path BP-1. Test 2 504 depicts high pressure from pump P-1 charging lines up to closed valves V-3 and V-2 (which are in parallel), with valve V-1 open and under high pressure between pump P-1 and valve V-3 and valve V-4 open and under low pressure between closed valve V-2 and bleed path BP-1. Test 3 503 depicts high pressure from pump P-1 charging lines up to closed valves V-1 and V-4 (which are in parallel), with valve V-2 open and under high pressure between pump P-1 and valve V-4 and valve V-3 open and under low pressure between closed valve V-1 and bleed path BP-1.

The table 508 depicts a relationship between what is required to be tested (e.g., which components are to be tested) and which test (of the gene) the component is tested in. In some embodiments, a component may be tested in one test of a gene or multiple tests of a gene. The table 508 shows that valve V-1 is tested from the left (e.g., L) to a required pressure of 5000 (e.g., psi) in test 1 and test 3. The table 508 shows that valve V-2 is tested from the left (e.g., L) to a required pressure of 5000 (e.g., psi) in test 1 and test 2. The table 508 shows that valve V-3 is tested from the left (e.g., L) to a required pressure of 5000 (e.g., psi) in test 2. The table 508 shows that valve V-4 is tested from the left (e.g., L) to a required pressure of 5000 (e.g., psi) in test 4. The table 508 shows that all the valves of the rig up may be tested using a smaller number of tests that the number of components. That is, the rig up contains four valves, but may be completely tested in three tests.

FIG. 6 is a diagram depicting an example rig up with an isolated cavity 600. An isolated cavity 600 is depicted for the rig up of FIGS. 3A, 4A, and 5. The isolated cavity 600 exists between valves V-1 and V-3 on flow path 602 when each of the valves V-1 and V-3 are sealed, in the depicted test. If valve V-1 is leaking, valve V-3 (which is also closed) has the potential to block fluid from exiting to the pressure sink, bleed path BP-1. This may mean that a leak of valve V-1 may be undetected by this test configuration. In one or more embodiments, isolated cavities may be preferentially selected against, such as during test plan generation, genetic algorithm application, etc.

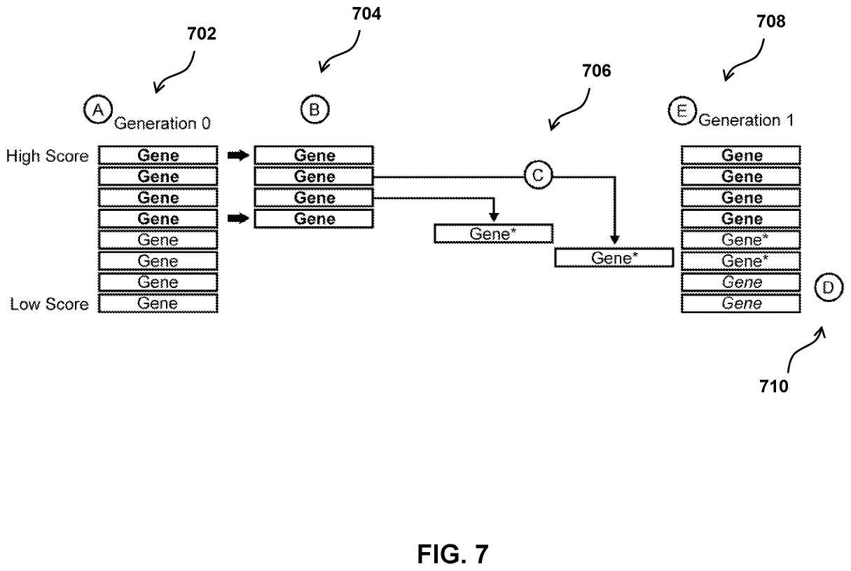

FIG. 7 is a schematic diagram depicting evolution of genes, according to some embodiments. Evolution from one generation to another is shown. Element A at evolution point 702 represents a first generation (Generation 0) created from a seeded (or existing) test plan or a randomized (or pseudo-randomized) set of Test Plans. Each Test Plan may correspond to a gene. The genes may then be scored (such as using a fitness score) and sorted (or ranked), such as from high score to low. Genes with high scores are depicted in bold and ranked more highly with genes with low scores, where high and low scores may be determined by comparison to a threshold score (and where the threshold score may vary, such as over time, iteration number, etc.) Element B at evolution point 704 represents an action where top scoring genes are conserved and bottom scoring genes are discarded, according to some embodiments. Bottom scoring genes may be remembered and new genes identical to bottom scoring genes may be removed if recreated in subsequent evolution. In element C at evolution point 706, some genes (e.g., from the top scoring genes) are randomly selected to mutate or crossover to generate a new set of genes. In some embodiments, mutation selection may be random, pseudo-random, ranked, directed, etc. In element E at evolution point 708, new random genes (e.g., not mutation results), depicted in italics, may also be generated for a new generation of genes. In element D at evolution point 710, a new generation (Generation 1) is formed (e.g., from high scoring genes of a previous generation, mutated genes, new random genes, etc.). Evolution points are used to describe steps in evolution of generations, but evolution may occur in more or fewer steps than depicts and described.

FIG. 8 depicts an exemplary method for test plan creation by a genetic algorithm, according to some embodiments. The operations of method 800 presented below are intended to be illustrative. In some embodiments, method 800 may be accomplished with one or more additional operations not described, and/or without one or more of the operations discussed. Additionally, the order in which the operations of method 800 are illustrated in FIG. 8 and described below is not intended to be limiting. In some embodiments, one or more portions of method 800 may be implemented in one or more processing devices (e.g., one or more processors). The one or more processing devices may include one or more devices executing some or all of the operations of method 800 in response to instructions stored electronically on an electronic storage medium. The one or more processing devices may include one or more devices configured through hardware, firmware, and/or software to be specifically designed for execution of one or more of the operations of method 800, for example.

At an operation 802, genes are created. The genes may contain one or more test, such as a set of test plans. The genes may contain information about how the tests of the test plan are created, such as a table as described in FIG. 5. The genes may be any appropriate genes such as previously described.

At an operation 804, the genes may be scored, such as by a fitness score. The fitness score may be any appropriate measure of fitness, such as a measure of completeness (e.g., does the gene test all required components), a measure of wear (e.g., does the gene subject some components to more stress or pressure than strictly required), a measure of efficiency (e.g., how many tests does the gene contain), a measure of problem areas (e.g., does the gene contain open flow paths, isolated cavities, over pressurization, etc.), etc. Each gene may have a fitness score, which may be absolute or relative (e.g., relative to other genes).

At an operation 806, the genes may be ranked by fitness, such as by fitness score. The ranking may be a binning, e.g., into high and low fitness score groups. The ranking may include ordinal ranking of each gene. The ranking may be divided by one or more threshold value of the fitness score.

At an operation 808, it may be determined if the test plans of the genes converge. Convergence may mean that the highly ranked genes contain similar test plans. Convergence may mean that a single highly ranked gene satisfies all criterion on the test plan. Convergence may mean that one or more gene has a substantially perfect fitness score. Convergence may be any appropriate convergence criterion for the genetic algorithm. If it is determined that the test plans of the genes converge, flow continues to operation 816 where the test plans of the genes are saved. If it is determined that the test plans of the genes do not converge, flow continues to operation 810.

At the operation 810, low scoring genes are removed from the genes. That is, genes with low fitness scores may be removed from the set of genes which were ranked. The low scoring genes may be discarded. The low scoring genes may be remembered (e.g., stored in a low scoring gene bank) so that any additional genes created through generation of new genes identical to the low scoring genes may be preemptively removed. For example, one a gene is identified as low scoring, it may be blocked from re-entering the set of genes, even though mutation.

At an operation 812, new genes are generated such as by mutation and crossover of the high scoring genes. Mutation and crossover may be any appropriate genetic mutation operation, such as test swapping, partial test swapping, combination, etc. The new genes may be generated based on the high (or highest) scoring genes of a previous generation. The new genes generated by mutation and cross over may be added to the high scoring genes of the previous iteration to create a new set of genes for testing.

At an operation 814, random genes are generated. The random (or pseudo random) genes may be generated by any appropriate manner, such as by those applied in the operation 802. The randomly generated genes may be added to the high scoring genes of the previous iteration along with the mutated and crossed over genes to create a new set of genes for testing. Flow then continues to the operation 804 where genes of the current iteration are scored, such as by fitness scores.

FIGS. 9A-9C are schematic diagrams depicting a relationship between generations of genes, according to some embodiments. FIG. 9A depicts a visual representation of a Generation 0 containing Gene 0 and Gene 1, while FIG. 9C depicts a visual representation of a Generation 1 containing Gene 1 and Gene 0 (where Gene 0 and Gene 1 may vary across generations). Each generation is depicted as containing multiple genes, where each gene corresponds to a single Test Plan. Evolution from Generation 0 to Generation 1 is shown by the differences between Generation 0 and Generation 1. Gene 0 is maintained, in its original form as a high scoring gene, from Generation 0 to Generation 1. Gene 1 of Generation 0 is removed (e.g., in the evolution) because it received a low score—for example due to an isolated cavity. Gene 0 of Generation 1 is mutated to produce Gene 1 of Generation 1. For example, Gene 0 may be mutated by use of a genetic algorithm. The genes of a generation may be scored and sorted to produce a new generation of genes. Each generation (e.g., Generation 0 of FIG. 9A and Generation 1 of FIG. 9C) contains a table depicting which components are to be tested and which tests (e.g., of the gene) they are tested in, such as previously described in reference to FIG. 5. Gene 1 of Generation 0 may be identified as an optimal Test Plan, for example because it may have a higher score (e.g., fitness score) resulting from a minimal number of tests.

FIG. 9B depicts example elements used to create (e.g., evolve) a subsequent generation (of genes) from a previous generation (of genes), according to some embodiments. In an exemplary method 900 of FIG. 9B, elements previously described in reference to FIG. 8 retain their original reference characters for ease of description. A generation 0 may be subjected to the following operations: the operation 810 which may remove low scoring genes, the operation 812 which may mutate and crossover one or more genes of the generation 0 to generation additional genes to add to the genes of generation 0, the operation 814 which may generate random genes to add to the genes of generation 0, the operation 804 which may score the fitness of the genes of generation 0, and the operation 806 which may sort the genes of generation 0 by fitness. The method may output a generation 1, which may contain the genes of generation 0, mutated genes based on genes of generation 0, and additional randomly generated genes which have fitness scores above a threshold.

FIG. 10 depicts an example process flow, according to some embodiments. The process flow, which may include Theia or another software component, may optimize Test Plans, which may include cases in which multiple optimal Test Plans are determined. Multiple optimal Test Plans may encompass similar Test Plans, Test Plans with similar scores (e.g., fitness scores), undifferentiated Test Plans output as a result of a time out termination criterion, etc. Element A at flow point 1002 corresponds to a set of genes, with fitness scores, such as those produced using a genetic algorithm (GA) from Theia. Element B at flow point 1004 corresponds to a set of Test Plans (e.g., candidate Test Plans) which contain the genes of element A—e.g., the genes encapsulate the candidate Test Plans. In some embodiments, it can be assumed that the candidate Test Plans contain tests which pressure test all required equipment, and which contain no errors. For example, Theia may validate candidate Test Plans. At element C at flow point 1006, a user may select a Test Plan (e.g., a starting Test Plan). In some embodiments, a facility may use (e.g., run) Greenlight or another software component to perform the tests of a selected Test Plan. In some embodiments, Greenlight or another software component may output a GRX file. As depicted in element D at flow point 1008, in some embodiments, the candidate Test Plans and, optionally, a GRX file such as output by Greenlight, may be fed into a prediction algorithm which may look at historical use of components (or other equipment), recent testing data, etc. and select a Test Plan from among the candidate Test Plans that may reduce high pressure on components. A selected Test Plan may be used for a subsequent test series, as depicted by element E at flow point 1010. The prediction may then be repeated, based on additional test results, for other iterations (as depicted in element F at flow point 1012 and at flow point 1014).

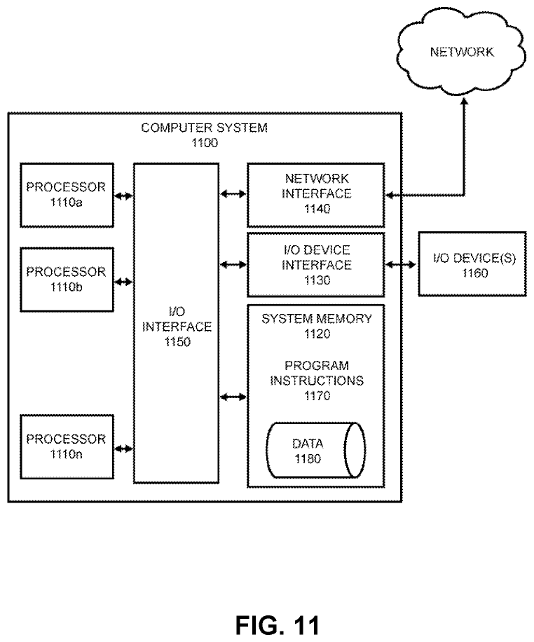

FIG. 11 is a diagram that illustrates an exemplary computing system 1100 by which embodiments of the present technique may be implemented. Various portions of systems and methods described herein, may include or be executed on one or more computer systems similar to computing system 1100. Further, processes and modules described herein may be executed by one or more processing systems similar to that of computing system 1100.

Computing system 1100 may include one or more processors (e.g., processors 1110a-1110n) coupled to system memory 1120, an input/output I/O device interface 1130, and a network interface 1140 via an input/output (I/O) interface 1150. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1100. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1120). Computing system 1100 may be a uni-processor system including one processor (e.g., processor 1110a), or a multi-processor system including any number of suitable processors (e.g., 1110a-1110n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1100 may include a plurality of computing devices (e.g., distributed computer systems) to implement various processing functions.

I/O device interface 1130 may provide an interface for connection of one or more I/O devices 1160 to computing system 1100. I/O devices may include devices that receive input (e.g., from a user) or output information (e.g., to a user). I/O devices 1160 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1160 may be connected to computing system 1100 through a wired or wireless connection. I/O devices 1160 may be connected to computing system 1100 from a remote location. I/O devices 1160 located on remote computer system, for example, may be connected to computing system 1100 via a network and network interface 1140.

Network interface 1140 may include a network adapter that provides for connection of computing system 1100 to a network. Network interface may 1140 may facilitate data exchange between computing system 1100 and other devices connected to the network. Network interface 1140 may support wired or wireless communication. The network may include an electronic communication network, such as the Internet, a local area network (LAN), a wide area network (WAN), a cellular communications network, or the like.

System memory 1120 may be configured to store program instructions 1170 or data 1180. Program instructions 1170 may be executable by a processor (e.g., one or more of processors 1110a-1110n) to implement one or more embodiments of the present techniques. Program instructions 1170 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1120 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard-drives), or the like. System memory 1120 may include a non-transitory computer readable storage medium that may have program instructions stored thereon that are executable by a computer processor (e.g., one or more of processors 1110a-1110n) to cause the subject matter and the functional operations described herein. A memory (e.g., system memory 1120) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1150 may be configured to coordinate I/O traffic between processors 1110a-1110n, system memory 1120, network interface 1140, I/O devices 1160, and/or other peripheral devices. I/O interface 1150 may perform protocol, timing, or other data transformations to convert data signals from one component (e.g., system memory 1120) into a format suitable for use by another component (e.g., processors 1110a-1110n). I/O interface 1150 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 1100 or multiple computing systems 1100 configured to host different portions or instances of embodiments. Multiple computing systems 1100 may provide for parallel or sequential processing/execution of one or more portions of the techniques described herein.

Those skilled in the art will appreciate that computing system 1100 is merely illustrative and is not intended to limit the scope of the techniques described herein. Computing system 1100 may include any combination of devices or software that may perform or otherwise provide for the performance of the techniques described herein. For example, computing system 1100 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 1100 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from a computer system may be transmitted to computer system via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

1.-5. (canceled)

6. A method for determining a pressure test plan comprising:
obtaining, by a computer system, a layout of fluidic connections of a plurality of pressure components;
identifying, by the computer system, a set of pressure components of the plurality for pressure testing;
obtaining, by the computer system, a test plan comprising a set of one or more pressure tests;
determining, by the computer system, a fitness score for the test plan; and
outputting, by the computer system, the test plan for application to the plurality of pressure components based on the fitness score.

7. The method of claim 6, wherein obtaining the test plan comprises generating the test plan based on the layout of fluidic connections and the set of identified pressure components, each pressure test corresponding to a testing tuple for at least one of the set of identified pressure components, the testing tuple comprising at least one of component test side, sealing state, and pressure.

8. The method of claim 7, wherein generating the test plan comprises generating at least one pressure test for each testing tuple of the identified pressure components.

9. The method of claim 8, wherein a given pressure test may correspond to multiple testing tuples, each of the multiple testing tuples for different of the identified pressure components.

10. The method of claim 6, wherein determining a fitness score for the test plan comprises determining the fitness score for the test plan based on at least one of test plan completeness with respect to the set of pressure components, pressure of the test plan, number of pressure tests of the test plan, and presence of flow errors in pressure tests of the test plan.

11. The method of claim 10, wherein flow errors comprises at least one of an open flow path, an isolated cavity, and an over pressurization.

12. The method of claim 6, wherein obtaining the test plan comprises obtaining a plurality of test plans, wherein determining a fitness score for the test plan comprises determining fitness scores for the plurality of test plans and wherein outputting the test plan comprises outputting at least one of the plurality of test plans for application to the plurality of pressure components based on the fitness scores.

13. The method of claim 12, wherein a test plan comprises a gene, and wherein outputting at least one of the plurality of test plans for application comprises steps for application of a genetic algorithm.

14. The method of claim 12, wherein outputting the test plan comprises outputting one or more optimal test plan for application to the plurality of pressure components based on the fitness scores.

15. The method of claim 12, determining the fitness scores for the plurality of test plans comprises:
determining a given fitness score for each of the test plans of the plurality of test plans;
selecting a subset of test plans from the plurality based on their fitness scores; and
generating a subsequent plurality of test plans from the selected subset of test plans;
wherein outputting at least one of the plurality of test plans comprises outputting at least one of the subsequent plurality of test plans.

16. The method of claim 15, wherein generating the subsequent plurality of test plans comprises generating the subsequent plurality of test plans based on genetic evolution of the selected subset of test plans.

17. The method of claim 15, wherein generating the subsequent plurality of test plans further comprises generating additional test plans by methods other than genetic evolution.

18. The method of claim 15, wherein selecting a subset of test plans from the plurality comprises ranking the test plans of the plurality based on their fitness scores and selecting the subset based on the ranking.

19. The method of claim 15, further comprising iteratively generating the subsequent plurality of test plans based on the plurality of test plans until a termination criterion is reached and outputting the at least one of the subsequent plurality of test plans after the termination criterion is reached.

20. The method of claim 15, further comprising steps for mutation of genes, wherein the test plans of the plurality comprise genes.

21. The method of claim 6, further comprising applying the test plan to the plurality of pressure components.

22. The method of claim 21, further comprising determining characteristics of the plurality of pressure components based on the applied test plan.

23. One or more non-transitory, machine-readable medium having instructions thereon, the instructions when executed by a processor configured to:
obtain a layout of fluidic connections of a plurality of pressure components;
identify a set of pressure components of the plurality for pressure testing;
obtain a test plan comprising a set of one or more pressure tests, each pressure test corresponding to a testing tuple for at least one of the set of identified pressure components, the tuple comprising at least one of component test side, sealing state, and pressure;
determine a fitness score for the test plan, the fitness score based on at least one of test plan completeness with respect to the set of pressure components, pressure of the test plan, number of pressure tests of the test plan, and presence of flow errors in pressure tests of the test plan; and
output the test plan for application to the plurality of pressure components based on the fitness score.

24. A system comprising:
a processor; and
one or more non-transitory, machine-readable medium having instructions thereon, the instructions when executed by the processor configured to:
obtain a layout of fluidic connections of a plurality of pressure components;
identify a set of pressure components of the plurality for pressure testing;
obtain a test plan comprising a set of one or more pressure tests, each pressure test corresponding to a testing tuple for at least one of the set of identified pressure components, the tuple comprising at least one of component test side, sealing state, and pressure;
determine a fitness score for the test plan, the fitness score based on at least one of test plan completeness with respect to the set of pressure components, pressure of the test plan, number of pressure tests of the test plan, and presence of flow errors in pressure tests of the test plan; and
output the test plan for application to the plurality of pressure components based on the fitness score.

25. The system of claim 24, further comprising one or more pressure component of the plurality of pressure components, the processor further configured to control the one or more pressure component to apply the output test plan.
